(19) United States
(12) Patent Application Publication
(10) Pub. No.: US 2026/0245038 A1
(43) Pub. Date: Aug. 20, 2026

(54) SYSTEMS AND METHODS FOR IMPROVED COMPUTER EFFICIENCY IN MAXIMIZING CAPACITY UTILIZATION WITH PREBUILD CONSTRAINTS

(71) Applicant: Kinaxis Inc., Ottawa (CA)

(72) Inventors: Pedram Falsafi, Ottawa (CA); Harjot Singh Dhindsa, Manotick (CA); Sriprasadh Raghunathan, Ottawa (CA); Paul Sun Zhang, Ottawa (CA)

(73) Assignee: Kinaxis Inc., Ottawa (CA)

(21) Appl. No.: 19/543,942

(22) Filed: Feb. 19, 2026

Related U.S. Application Data
(60) Provisional application No. 63/760,177, filed on Feb. 19, 2025.
(60) Provisional application No. 63/830,121, filed on Jun. 25, 2025.
(60) Provisional application No. 63/831,694, filed on Jun. 27, 2025.

(51) Int. Cl. G06Q 10/087

(52) U.S. Cl. CPC G06Q 10/0874

(57) ABSTRACT

Systems and methods for maximizing capacity utilization with constraints, determine a buffer of an already-built (that is, existing) inventory and suggest an increased limit for new inventory that can lead to maximization of capacity. This approach includes the construction of a dynamic ordered buffer list, and a smart search that searches only viable portions of the ordered list for a buffer.

This application claims priority on U.S. Ser. No. 63/760,177 filed on Feb. 19, 2025, U.S. Ser. No. 63/830,121 filed on Jun. 25, 2025, and U.S. Ser. No. 63/831,694 filed on Jun. 27, 2025, each of which is incorporated herein in its respective entirety, by reference.

### BACKGROUND

In a constrained manufacturing environment with limited capacity, orders prefer to secure capacity closest to their requested date to minimize the inventory holding cost. However as capacity is being used up and not enough capacity is found near the desired demand date, there is a need for prebuild (that is, making supply earlier than requested) by doing longer prebuilding to prebuild for future forecasted demands.

This prebuild can be challenging when material is perishable (that is, subject to expiry) since prebuilding cannot be longer than the shelf life of the material. Otherwise supply will expire before the required shelf life of its demands.

This challenge leads to limited prebuilding and undesired and unconsumed capacity which could be used up otherwise and eventually causes late or unsatisfied demand. This challenge can also lead to supplies being built in lumps, instead of smoothly, over time, increasing manufacturing costs and wasting capacity.

Traditional solutions to this problem include iterations and swapping the capacity allocations. However, these result in slow algorithms, which typically have a time complexity of O(N\hat{ }2, ‘N’ being the number of demands) which makes these algorithms impractical, since there are typically thousands, if not hundreds of thousands, of demands.

### BRIEF SUMMARY

Systems and methods disclosed herein provide a technical solution to traditional slow algorithms that try to address prebuilds having an expiry date. Systems and methods disclosed herein calculate the excess shelf life (time on the shelf in excess of the required shelf life) of an already-built (that is, existing) inventory and suggests an increased prebuilding limit for new inventory that can lead to improved shelf life of the inventory and at the same time satisfy the demands with reduced risk of expiry. Systems and methods disclosed herein result in algorithms bounded by O(N log N), which is a vast improvement over traditional methods, in terms of computer speed performance. In conventional methods, the algorithms are bounded by O(N\hat{ }2).

In one aspect, a system is provided that includes a processor. The system also includes a memory storing instructions that, when executed by the processor, configure the system to: select an order from a sequence of orders; determine a buffer limit for the order from conditions placed on the order. Where there is capacity within the buffer limit to fill the order, the system also includes a memory storing instructions that, when executed by the processor, configure the system to: instruct an entity to fill the order; and determine whether buffer information should be added to an ordered buffer list based on a pre-order limit and a pre-order term associated with the order. Where there is no capacity within the buffer limit to fill the order, the system also includes a memory storing instructions that, when executed by the processor, configure the system to: search a portion of the ordered buffer list beginning at a point nearest to the buffer limit; select a buffer within the ordered buffer list that is within the buffer limit; extend the buffer limit; instruct the entity to fill the order within the extended buffer limit; and remove the selected buffer from the ordered buffer list.

The system may also include where the ordered buffer list is a binary tree structure. When there is no buffer in the ordered prebuild buffer list that is within the buffer limit, the system may be configured to mark the order as late. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer: to select an order from a sequence of orders; and determine a buffer limit for the order from conditions placed on the order. Where there is capacity within the buffer limit to fill the order, the non-transitory computer-readable storage medium also includes instructions that when executed by the computer, cause the computer to: instruct an entity to fill the order; and determine whether buffer information should be added to an ordered buffer list based on a pre-order limit and a pre-order term associated with the order. Where there is no capacity within the buffer limit to fill the order, the non-transitory computer-readable storage medium also includes instructions that when executed by the computer, cause the computer to: search a portion of the ordered buffer list beginning at a point nearest to the buffer limit; select a buffer within the ordered buffer list that is within the buffer limit; extend the buffer limit, instruct the entity to fill the order within the extended buffer limit; and remove the selected buffer from the ordered buffer list.

The non-transitory computer-readable storage medium may also include where the ordered buffer list is a binary tree structure. The non-transitory computer-readable storage medium may also include where when there is no buffer in the ordered prebuild buffer list that is within the buffer limit, the computer is configured to mark the order as late. Other technical features may be readily apparent to one skilled in the art from the following figures, descriptions, and claims.

In one aspect, a computer-implemented method for maximizing capacity utilization with prebuild constraints is provided, the method includes: selecting, by a processor, an order from a sequence of orders; and determining, by the processor, a buffer limit for the order from conditions placed on the order. Where there is capacity within the buffer limit to fill the order, The computer-implemented method also includes: instructing, by the processor, an entity to fill the order; and determining, by the processor, whether buffer information should be added to an ordered buffer list based on a pre-order limit and a pre-order term associated with the order. Where there is no capacity within the buffer limit to fill the order, the computer-implemented method also includes: searching, by the processor, a portion of the ordered buffer list beginning at a point nearest to the buffer limit; selecting, by the processor, a buffer within the ordered buffer list that is within the buffer limit; extending, by the processor, the buffer limit; instructing, by the processor, the entity to fill the order within the extended buffer limit; and removing, by the processor, the selected buffer from the ordered buffer list. The computer-implemented method may also include where the ordered buffer list is a binary tree structure. When there is no buffer in the ordered prebuild buffer list that is within the buffer limit, the method further includes marking, by the processor, the order as late. Other technical features may be readily apparent to one skilled in the art from the following figures, descriptions, and claims.

In one aspect, a system is provided that includes a processor. The system also includes a memory storing instructions that, when executed by the processor, configure the system to: select a demand from a sequence of demands; and obtain a prebuild limit from a demand shelf life of the demand, and a supply shelf life of a supply. Where there is capacity within the prebuild limit to fill the demand the system also includes a memory storing instructions that, when executed by the processor, configure the system to: instruct an entity to make the supply; and determine whether information related to a prebuild buffer associated with the supply should be added to an ordered buffer list, based on the prebuild limit and a prebuild term associated with the order. Where there is no capacity within the prebuild limit to fill the demand, the system also includes a memory storing instructions that, when executed by the processor, configure the system to: search a portion of the ordered prebuild buffer list beginning at a nearest date to the prebuild limit; select a prebuild buffer within the ordered prebuild buffer list that is within the prebuild limit; extend the prebuild limit; instruct the entity to make the supply; and remove the selected prebuild buffer from the ordered prebuild buffer list.

When there is no prebuild buffer in the ordered prebuild buffer list that is within the prebuild limit, the system can be configured to: mark the demand as late. The system may also include where the information related to the prebuild buffer includes: a supply generated for the prebuild buffer is set equal to the supply associated with the prebuild buffer; and a prebuild buffer date is set equal to a prebuild limit date of the demand. The system may also include where the ordered prebuild buffer list is a binary tree structure. The system may also include where when the prebuild term is less than the prebuild limit, the system is configured to: add information related to the prebuild buffer associated with the supply to the ordered prebuild buffer list that is listed in chronological order of a prebuild demand limit associated with the supply. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to: select a demand from a sequence of demands; and obtain a prebuild limit from a demand shelf life of the demand; and a supply shelf life of a supply. Where there is capacity within the prebuild limit to fill the demand, the non-transitory computer-readable storage medium also includes instructions that when executed by the computer, cause the computer to: instruct an entity to make the supply, and determine whether information related to a prebuild buffer associated with the supply should be added to an ordered buffer list, based on the prebuild limit and a prebuild term associated with the order. Where there is no capacity within the prebuild limit to fill the demand, the non-transitory computer-readable storage medium also includes instructions that when executed by the computer, cause the computer to: search a portion of the ordered prebuild buffer list beginning at a nearest date to the prebuild limit; select a prebuild buffer within the ordered prebuild buffer list that is within the prebuild limit; extend the prebuild limit; instruct the entity to make the supply; and remove the selected prebuild buffer from the ordered prebuild buffer list.

When there is no prebuild buffer in the ordered prebuild buffer list that is within the prebuild limit, the computer may be configured to mark the demand as late. The non-transitory computer-readable storage medium may also include where the information related to the prebuild buffer includes: a supply generated for the prebuild buffer is set equal to the supply associated with the prebuild buffer; and a prebuild buffer date is set equal to a prebuild limit date of the demand. The non-transitory computer-readable storage medium may also include where the ordered prebuild buffer list is a binary tree structure. The non-transitory computer-readable storage medium may also include where when the prebuild term is less than the prebuild limit, the computer is configured to: add information related to the prebuild buffer associated with the supply to the ordered prebuild buffer list that is listed in chronological order of a prebuild demand limit associated with the supply. Other technical features may be readily apparent to one skilled in the art from the following figures, descriptions, and claims.

In one aspect, a computer-implemented method is provided, the method includes: selecting, by a processor, a demand from a sequence of demands; and obtaining, by the processor, a prebuild limit from a demand shelf life of the demand, and a supply shelf life of a supply. Where there is capacity within the prebuild limit to fill the demand, the computer-implemented method also includes: instructing, by the processor, an entity to make the supply; and determining, by the processor, whether information related to a prebuild buffer associated with the supply should be added to an ordered buffer list, based on the prebuild limit and a prebuild term associated with the order. Where there is no capacity within the prebuild limit to fill the demand, the computer-implemented method also includes: searching, by the processor, a portion of the ordered prebuild buffer list beginning at a nearest date to the prebuild limit; selecting, by the processor, a prebuild buffer within the ordered prebuild buffer list that is within the prebuild limit; extending, by the processor, the prebuild limit; instructing, by the processor, the entity to make the supply; and removing, by the processor, the selected prebuild buffer from the ordered prebuild buffer list.

When there is no prebuild buffer in the ordered prebuild buffer list that is within the prebuild limit, the method may further include: marking, by the processor, the demand as late. The computer-implemented method may also include where the information related to the prebuild buffer includes: a supply generated for the prebuild buffer is set equal to the supply associated with the prebuild buffer, and a prebuild buffer date is set equal to a prebuild limit date of the demand. The computer-implemented method may also include where the ordered prebuild buffer list is a binary tree structure. When the prebuild term is less than the prebuild limit, the method may further include: adding, by the processor, information related to a prebuild buffer associated with the supply to the ordered prebuild buffer list. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for improved computer efficiency in maximizing capacity utilization with prebuild constraints, in accordance with one embodiment.

FIG. 2 illustrates a prebuild limit in accordance with one embodiment.

FIG. 3A illustrates conventional processing of a first demand in a sequence of demands having a prebuild limit.

FIG. 3B illustrates conventional processing of a second demand in a sequence of demands having a prebuild limit.

FIG. 3C illustrates conventional processing of a third demand in a sequence of demands having a prebuild limit.

FIG. 3D illustrates conventional processing of a fourth demand in a sequence of demands having a prebuild limit.

FIG. 4A illustrates conventional processing of four demands sequentially, where each demand has a prebuild limit.

FIG. 4B illustrates planning the processing of four demands using traditional methods of swapping and iteration.

FIG. 5 illustrates a block diagram in accordance with one embodiment.

FIG. 6 illustrates a block diagram for deciding whether or not to add information to an ordered prebuild buffer list in accordance with one embodiment.

FIG. 7 illustrates a block diagram for finding a prebuild buffer with enough shelf life to fill a demand, in accordance with one embodiment.

FIG. 8A illustrates processing of demand D1, in accordance with one embodiment.

FIG. 8B illustrates processing of demand D2 further to FIG. 8A, in accordance with one embodiment.

FIG. 8C illustrates processing of demand D3 further to FIG. 8B, in accordance with one embodiment.

FIG. 8D illustrates processing of demand D4 further to FIG. 8C, in accordance with one embodiment.

FIG. 8E illustrates allotment of demands D1-D4 further to FIG. 8D, in accordance with one embodiment.

FIG. 9 illustrates allotment of demands D1-D4 further to FIG. 8E, in accordance with one embodiment.

FIG. 10 illustrates an example of constructing and searching an ordered buffer list, in accordance with one embodiment.

FIG. 11 illustrates an example of constructing and searching an ordered buffer list, in accordance with one embodiment.

FIG. 12 illustrates an example of constructing and searching an ordered buffer list, in accordance with one embodiment.

FIG. 13 illustrates a block diagram in accordance with one embodiment.

FIG. 14 illustrates a block diagram for for deciding whether or not to add information to an ordered buffer list in accordance with one embodiment.

FIG. 15 illustrates a block diagram for finding a buffer in the buffer list that can fill the order, in accordance with one embodiment.

FIG. 16A illustrates improvement in computer processing time in accordance with one embodiment.

FIG. 16B illustrates improvement in computer processing time in accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit including custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, include one or more physical or logical blocks of computer instructions which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which includes one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

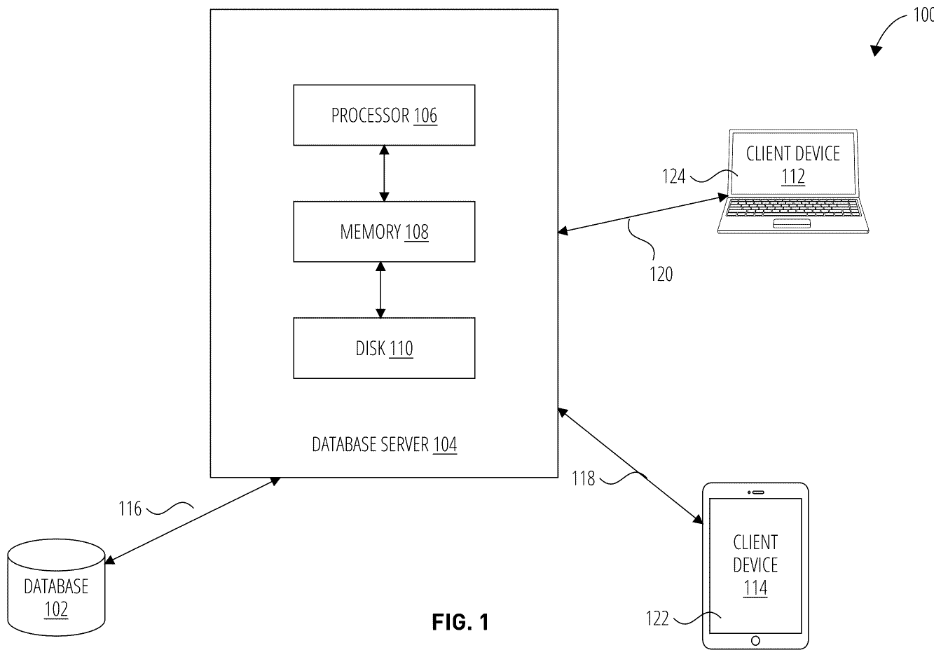

FIG. 1 illustrates an example of a system 100 for a system improved computer efficiency in maximizing capacity utilization with prebuild constraints, in accordance with one embodiment.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also include a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

In the present disclosure, the terms “process” and “algorithm” are used interchangeably, and may refer to a set of steps performed in relation to an in-memory database, such as a versioned database. As referred to herein, for example, a deterministic process may be considered to be equivalent to a deterministic algorithm. A deterministic algorithm always produces the same output given a particular input. For example, an algorithm that always returns an output of Y with an input of X is deterministic. So, every time there is an input of X, it is known that the answer is Y. The result does not have to be unique, for example an input of Q can also return an output of Y, just deterministic. For a deterministic algorithm, once the input is known, the answer or output is already known, and it is not necessary to send the input to the algorithm at all.

In some implementations, a server memory may store an in-memory database as well as calculated results from processes or algorithms that are executed in relation to contents of the in-memory database. In some implementations, the calculated results may include about half of the server memory.

Reference to “in-memory” storage may refer to a server memory associated with database server 104, which may include memory 108 and/or database 102. Reference to “on-disk” storage may refer to disk 110 and/or other disks, for example disks associated with cloud storage.

In known approaches, both data (e.g. a versioned database) and calculations (e.g. calculated results) are stored in-memory. Such an approach is fast but also expensive. There is also a drawback that calculated results stored in-memory do not persist to disk when the server is restarted. The first time a calculation is performed, not only do all of the records need to be in-memory, but also the calculation structures must be built up in memory.

Embodiments of the present disclosure save memory and improve performance. Embodiments of the present disclosure avoid the time required to re-calculate the results, even the first time after server startup. Servers may have complicated invalidation rules. Even if something is stored in-memory, if the database changes, the results may be incorrect. Analytics results may also be lost from memory if the server detects that it is running out of memory. Embodiments of the present disclosure seek to solve one or more problems associated with known approaches, including wasted time and resources spent recalculating results.

A deterministic process as referred to herein may include an embedded algorithm, such as a supply chain algorithm used to analyze or calculate results based on an in-memory versioned database. An embedded algorithm may be implemented as a C++ algorithm. A deterministic process may include a core algorithm the results of which may not be serializable, for example if they are in-memory C++ objects that refer to other memories and other pointers.

Embodiments of the present disclosure may establish two tiers of storage, where the system may promote or demote a result. According to known approaches, some databases only exist in-memory, or only on-disk. Embodiments of the present disclosure provide a method of demoting content from in-memory to on-disk, or promoting content from on-disk to in-memory, for example in response to a server command or indication. If a result is not previously calculated, it can go from nowhere to in-memory or on-disk. In-memory is typically one tier, but on-disk can be one or more tiers. Embodiments of the present disclosure may be configured to provide an n-tier solution, for example where cloud storage provides different types of disks with different speeds of access, and the system may promote/demote to faster or slower disks in different on-disk tiers. Promoting/demoting refers to moving the results around, and is with respect to speed of access to the memory or disk(s).

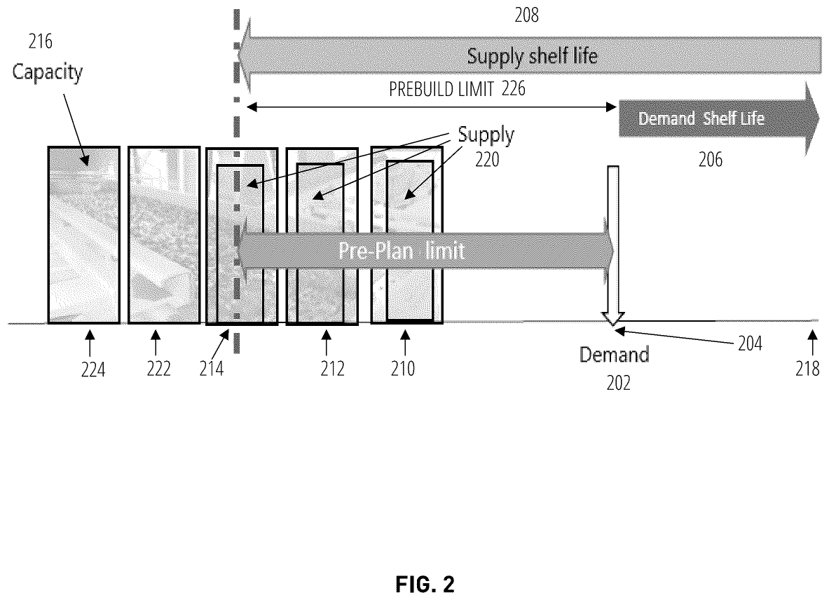

FIG. 2 illustrates a prebuild limit in accordance with one embodiment.

A demand 202 is made at date 204. In addition, the demand 202 has a demand shelf life 206. A demand shelf life can be defined as an amount of time that a (supplied) product is made available—that is, from the date demand 202 is filled (at 204) until demand shelf life 206 ends at date 218.

Demand 202 is filled by a supply 220, which has a supply shelf life 208. A supply shelf life can be defined as an amount of time that a product (provided by a supplier) lasts, before it expires. A capacity 216 is used to make supply 220. Supply 220 is not assigned simultaneously to three capacities; rather, in FIG. 2, supply 220 can be made by only one of the three capacities (either at the date indicated by 210, 212 or 214).

Capacity can be defined as resources (for example, labor, materials, equipment etc.) used to make a supply. In a prebuild, there can be time intervals, or dates, during which a supply can be made using capacity. In FIG. 2, for example, capacity 216 is available at dates indicated by 210, 212, 214, 222, and 224. Once a capacity is used to build supply, that capacity is not further available.

In prebuilds, however, supply 220 cannot expire while it is on the shelf of the demand. That is, supply 220 cannot expire before date 218. Therefore, supply shelf life 208 is greater than or equal to demand shelf life 206. These are used to determine a prebuild limit 226, which is defined as a difference between supply shelf life 208 and demand shelf life 206. In FIG. 2, therefore, supply 220 can only be built at any one of dates 210, 212, and 214. If supply 220 is built at either of dates 222 or 224, the supply 220 will expire before the end of demand shelf life 206.

As an example, a retailer orders a drug supply that is made available by the retailer for a period of 12 months. The period of 12 months is the demand shelf life in this example. On the other hand, a drug supplier manufactures the drug, and once packaged, lasts 18 months before expiring. The period of 18 months is the supply shelf life. In this example. An acceptable prebuild limit is the supply shelf life (18 months) minus the demand shelf life (12 months), which is equal to 6 months.

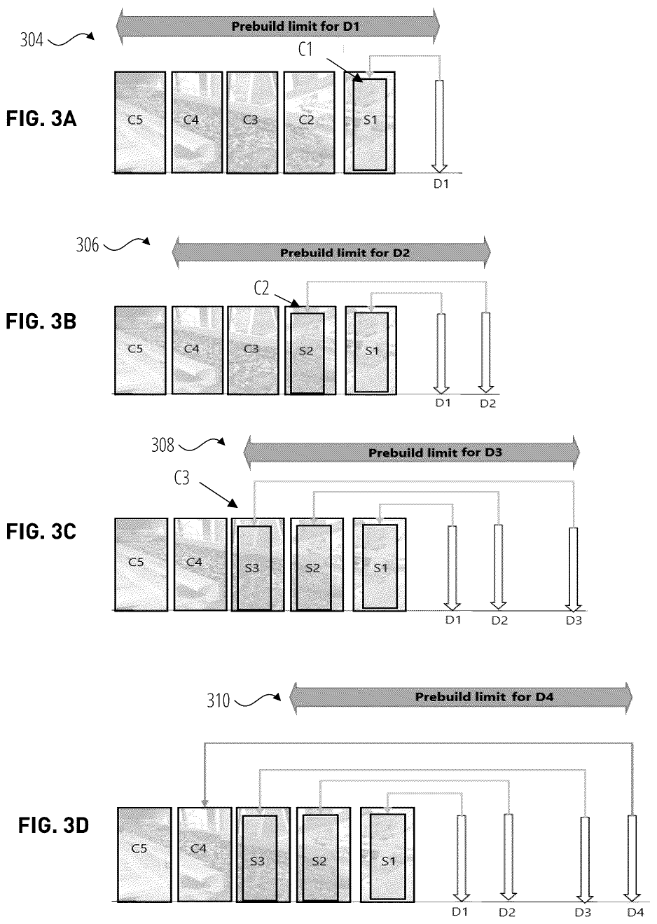

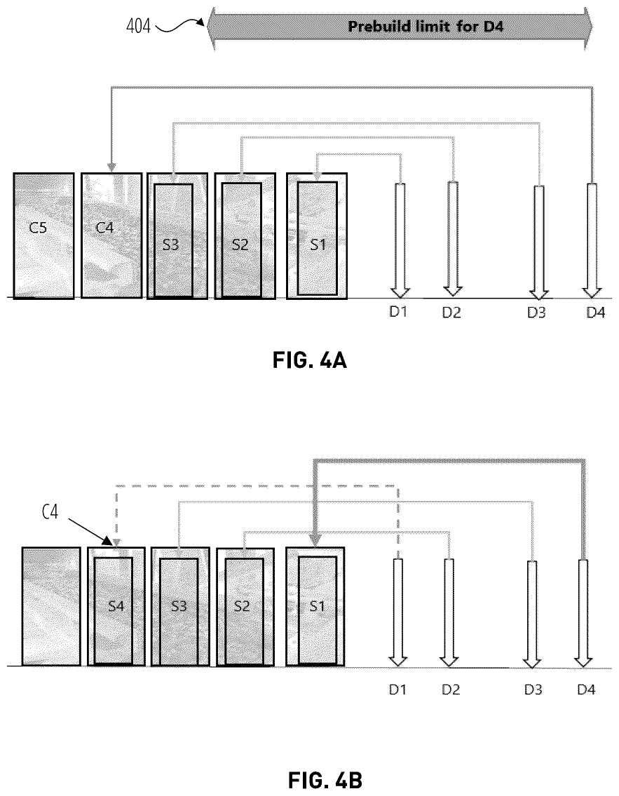

FIG. 3A-FIG. 3D illustrate a sequence of processing demands having a prebuild limit, according to conventional methods. There is a sequence of four demands (D1-D4) that are to be processed, as illustrated in FIG. 3A-FIG. 3D. In the conventional method, demands can be left unfilled, while capacity is left unused, leading to a waste of resources. This is illustrated in FIG. 3A-FIG. 3D, as follows.

In FIG. 3A, a first demand D1 is placed, having a prebuild limit 304 as shown. The supply can be made using any one of capacity C1, C2, C3, C4 and C5, that are all within the prebuild limit 304. However, in order to save resources and costs on storage of supply, a supplier builds supply S1 as close to demand D1 as possible. In FIG. 3A, the first demand D1 is fulfilled by supply S1 which is built using capacity C1. Once a capacity is used to build supply, that capacity is not further available. Therefore, for subsequent demands, C1 is not available to make supply. Once the first demand D1 is processed, the system moves to process the next demand in sequence, D2.

In FIG. 3B, a second demand D2 is processed, after processing demand D1. Demand D2 has prebuild limit 306 as shown. The supply for D2 (namely, S2) can be made using any one of capacity C2, C3, and C4, that are all within the prebuild limit 306. Note that C1 (which is within prebuild limit 306) is unavailable since it is used to prepare supply S1. C5 is not possible since it is beyond prebuild limit 306—any supply made using C5 will expire before the demand shelf life of D2 ends. As in FIG. 3A, in order to save resources and costs on storage of supply, a supplier builds supply S2 as close to demand D2 as possible. In FIG. 3B, the second demand D2 is fulfilled by supply S2 which is built using capacity C2. Once the second demand D2 is processed, the system moves to process the next demand in sequence, D3.

In FIG. 3C, a third demand D3 is processed, after processing demand D2. Demand D3 has prebuild limit 308 as shown. The supply for D3 (namely, S3) can be made using only capacity C3, which is within the prebuild limit 308. Note that C1 and C2 (both within prebuild limit 308) are unavailable since each is used to prepare supply S1 and S2, respectively. C4 and C5 are both not possible, since each capacity is beyond prebuild limit 308—any supply made using C4 or C5 will expire before the demand shelf life of D3 expires. As there is only once choice of capacity to build supply, the third demand D3 is fulfilled by supply S3 which is built using capacity C3. Once the third demand D3 is processed, the system moves to process the next demand in sequence, D4.

In FIG. 3D, a fourth demand D4 is processed, after processing demand D3. Demand D4 has prebuild limit 310 as shown. Only capacity C1 and C2 lie within prebuild limit 310; however these are unavailable since they are allotted to make supply S1 and S2, respectively. The only capacity available to make supply for D4 are C4 and C5; the closest capacity to D4 is C4. However C4 is beyond prebuild limit 310—any supply made using C4 (or C5) will expire before the demand shelf life of D4 expires. Therefore, demand D4 will not be filled on time, or may not be filled at all. Furthermore, there is unused capacity (namely C4 and C5). The conventional method of sequentially processing demands having a prebuild leads to unfilled (or late) demands and unused capacity, leading to inefficiency and waste.

FIG. 4A and FIG. 4B illustrate comparative features of processing four demands using two conventional approaches. FIG. 4A illustrates a first conventional approach, which is simply a summary of the sequence of figures FIG. 3A-FIG. 3D. In FIG. 4A, conventional processing of four demands is performed sequentially, where each demand has a respective prebuild limit. For sake of clarity, only prebuild limit for demand D4, 404, is shown. That is, FIG. 4A is a duplicate of FIG. 3D. In the conventional approach, demand D4 is late or unfilled, while there is unused capacity C4 and C5.

FIG. 4B illustrates a second conventional approach, in which processing of four demands is performed using a traditional approach of swapping and iteration. In FIG. 4B, all of the demand dates are known beforehand. In FIG. 4B, capacity C4 is used to make supply S4. However, the allotment of supplies is swapped between demand D1 and demand D4. That is, D1 can be filled by supply S4 (made by using capacity C4), while still maintaining the prebuild limit of D1, as shown in FIG. 3A. Similarly, demand D4 can be filled by S1 (made by using capacity C1), while still maintaining the prebuild limit of D4, as shown in FIG. 3D. Note that the allotments for D2 and D3 remain as they are.

In the approach shown in FIG. 4B, all demands are filled, and capacity is used efficiently. However, the process of swapping supply-demand allocations is computationally slow, requiring an iterative algorithm that is the order of N² (N being the number of demands). This is because in this conventional computational approach, each demand has to be iterated through of the order of ‘N’ times. For large-scale problems, where N is of the order 10² or above, this conventional approach of iterative swapping is impractical.

The technical problem is how to reduce computer processing time when maximizing capacity utilization within prebuild constraints. Technical solutions disclosed herein, overcome the need for enhanced computational processing times required for conventional iterative-swapping methods, by bypassing iterative-swapping methods altogether. Systems and methods disclosed herein result in computer processing times bounded by O(N log N), which is a large improvement over the traditional iterative-swapping methods that require computer processing times bounded by O(N²). Systems and methods disclosed herein include a process that keeps track of a prebuild buffer (which is a time buffer that a supply could have been built earlier within a prebuild limit) and utilizes prebuild buffers to allow for longer prebuild and capacity utilization. Such systems and methods avoid the iterative N² process of iteratively swapping each demand to find the schedule that maximizes capacity use within prebuild constraints.

As demands are being processed, systems and methods disclosed herein keep track of excess shelf life and use the excess shelf life as a buffer for future demands that need supply. This eliminates the need to iterate and swap, resulting in an algorithmic performance that significantly improves over traditional methods. The computing processing time for systems and methods disclosed herein, is far less than that required by the conventional iterative-swap method. Systems and methods disclosed herein employ algorithms that provide a highly performant way to calculate a dynamic optimum prebuild that respects both the demand shelf life and the supply shelf life, while maximizing capacity utilization, all the while using far less processing time than that required by the conventional iterative-swap method.

Systems and methods disclosed herein can include: a demand list, a prebuild, comparison of shelf lives, excess shelf life, generation of a prebuild buffer, an ordered prebuild buffer list, and buffer look up. These are briefly described as follows:

Demand list: a list of all the demands for which supplies are generated.

Prebuild: search for a suitable slot with enough capacity to build a supply for a demand before the demand due date.

Comparison of shelf lives: Compare a supply shelf life against a demand shelf life.

Excess shelf life: the amount of time that a product stays on the shelf beyond the minimum demand shelf life requirement.

Generation of a prebuild buffer: Calculate and store the excess shelf life that a supply can have.

Ordered prebuild buffer list: Keeps track of all the calculated prebuild buffers.

Buffer look up: Use of the prebuild buffer list to find a suitable (if any) buffer to consume.

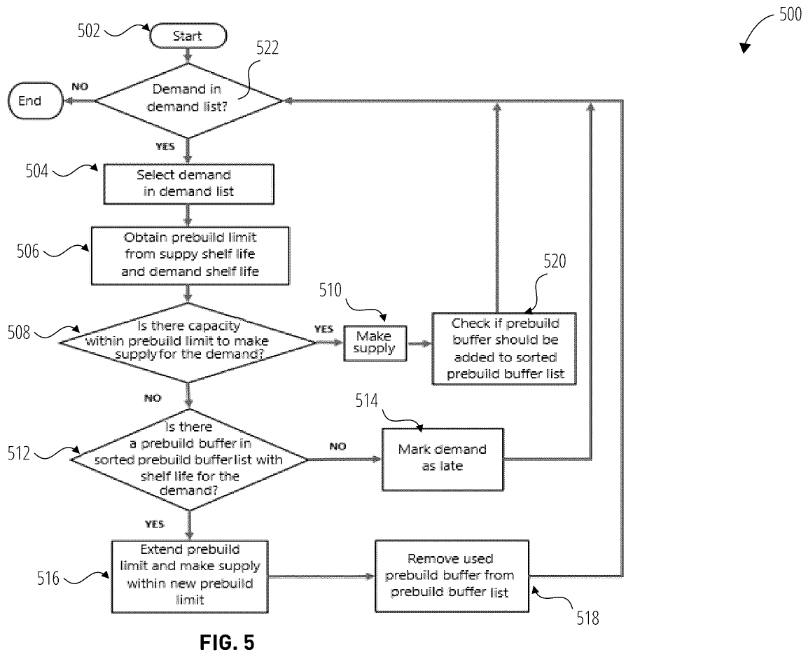

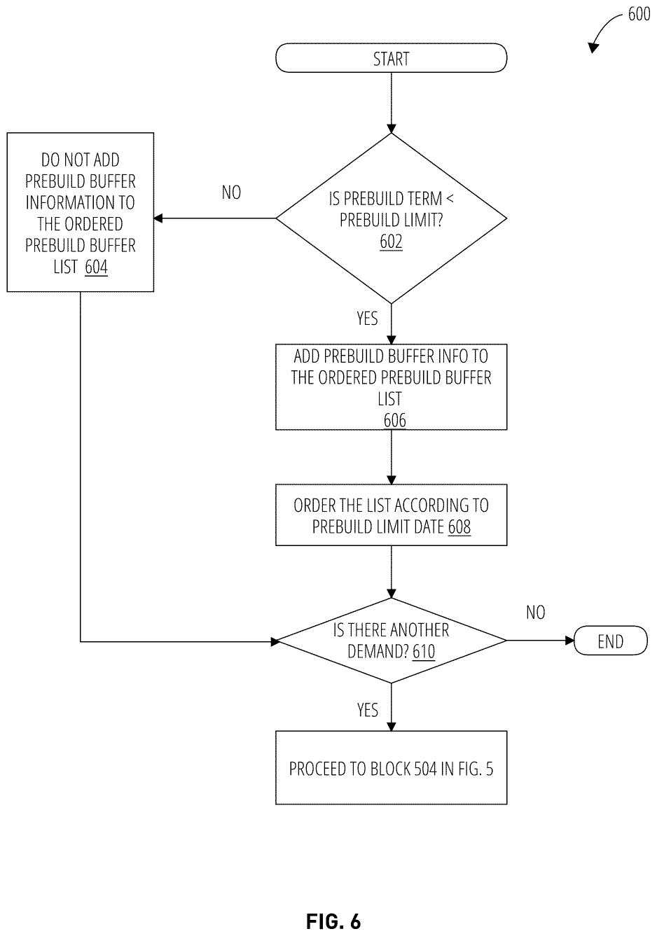

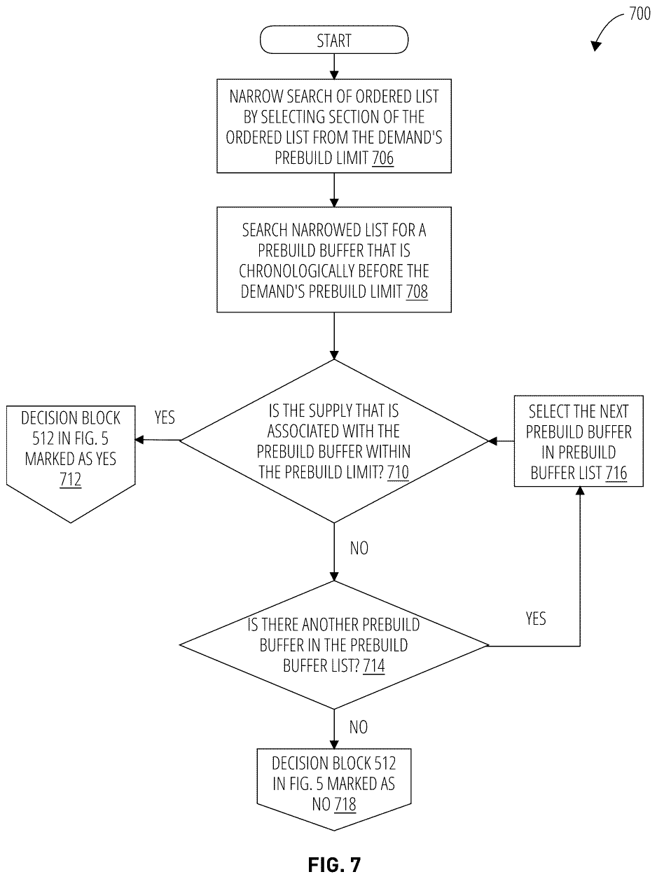

FIG. 5 illustrates a block diagram 500 for improved computer efficiency in maximizing capacity utilization with prebuild constraints, in accordance with one embodiment.

The first steps involve selecting a demand. At the outset, since there is a demand in a demand list (‘yes’ at decision block 502), the top demand in the demand list is selected for processing, at 504. The demand list can be arranged in any order. As an example, the demand list can be chronological, by priority, or any combination thereof.

Next, at 506, a prebuild limit for the demand is obtained from the supply shelf life and the demand shelf life. The prebuild limit is defined as the difference between the supply shelf life and the demand shelf life. In some embodiments, the prebuild limit is identical for all demands. As an example of an identical prebuild limit for all demands, in some embodiments, the supply shelf life is constant and the demand shelf life is the same for all demands, leading to an identical prebuild limit for all demands. On the other hand, in some embodiments, the prebuild limit varies from demand to demand. As an example of a prebuild limit varying from demand to demand, in some embodiments, the supply shelf life is constant while the demand shelf life differs from demand to demand, leading to more than one prebuild limit value.

Next, the system checks to see if the supply can be made using capacity within the prebuild limit at decision block 508. If the answer is ‘yes’, then the supply is made at block 510 and the system checks to see if a prebuild buffer (associated with that supply) is to be added to an ordered prebuild buffer list at block 520. An ordered list helps to improve algorithm efficiency. To improve algorithm efficiency, the prebuild buffers can be stored in a data structure that allows finding eligible buffers for a particular demand to be more efficient than linear search. For example, the data structure can be a list ordered by earliest usable dates of prebuild buffers, such as prebuild limit dates.

At block 520, if the supply shelf life is longer than the demand shelf life, this means that the supply could have been prebuilt using an earlier capacity. The earliest capacity that could have been used to make the supply, is termed a “prebuild buffer”. An embodiment for constructing a prebuild buffer list is illustrated in FIG. 6. The next demand in the list is processed at block 504; otherwise the process ends if there are no further demands in the demand list.

On the other hand, at decision block 508, if the supply cannot be built due to a lack of capacity within the prebuild limit (‘no’ at decision block 508), the ordered prebuild buffer list is checked for a prebuild buffer that has enough shelf life to satisfy this demand, at decision block 512. If no such prebuild buffer is found (‘no’ at decision block 512), the demand is marked as late at block 514. The system then proceeds to the next demand in the demand list, or ends if no more demands remain to be processed.

If, however, at decision block 512, a prebuild buffer can be found in the ordered prebuild buffer list that has enough shelf life to satisfy this demand (‘yes’ at decision block 512), then the prebuild limit of the demand is extended up to this prebuild buffer and a supply can be built with this new prebuild limit at block 516. Next, at block 518, the used prebuild buffer is removed from the ordered prebuild buffer list. The system then proceeds to the next demand in the demand list, or ends if no more demands remain to be processed.

FIG. 6 illustrates a block diagram 600 for deciding whether or not to add information to an ordered prebuild buffer list a in accordance with one embodiment. A prebuild term is first checked against a prebuild limit at decision block 602. The prebuild term is defined as the time interval between a demand and the making of a supply that fills the demand.

If the prebuild term is not less than the prebuild limit (‘no’ at decision block 602), then no information is added to the ordered prebuild buffer list (block 604). However, if the prebuild term is less than the prebuild limit (‘yes’ at decision block 602), then information about the prebuild buffer is added to the ordered prebuild buffer list. In some embodiments, this information can include the following: a supply associated with the prebuild buffer; and a prebuild buffer date is set equal to the prebuild limit date of the demand. Next, at block 608, the list is ordered according to the prebuild limit date, in chronological order. The ordered list is a data structure, which can be implemented as binary-tree structure.

Whether the decision is ‘yes’ or ‘no’ at decision block 602, the process eventually winds up at 610 to process the next demand (if there is one), which is equivalent to decision block 502 in FIG. 5; that is, if there is no further demand to process, then the process ends. If there is another demand to process, the process proceeds to block 504 of FIG. 5.

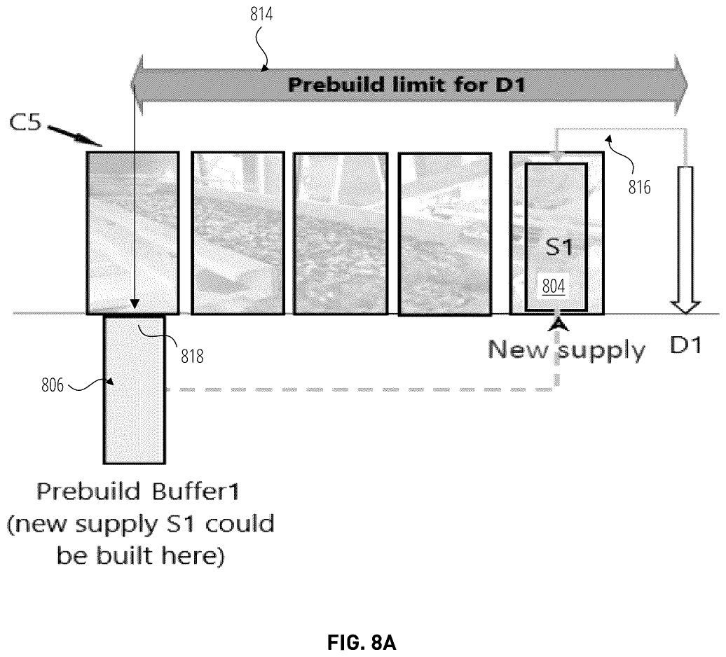

FIG. 7 illustrates a block diagram 700 for finding a prebuild buffer with enough shelf life to fill a demand, in accordance with one embodiment.

Rather than search the entire ordered list (which requires computing resources) for a prebuild buffer with enough shelf life to fill the demand, only a viable section of the ordered list is searched, thus leading to less use of computing resources. The ordered list is a data structure, that can be implemented as a binary-tree structure.

At block 706, search of the ordered list is narrowed by selecting a section of the ordered lists from the demand's prebuild limit. At block 708, the search is executed by searching the ordered list for a buffer that is chronologically before the demand's prebuild limit. That is because buffers that are available before the demand's prebuild limit will not have enough shelf life to fill the demand, and will thus not be viable. Thus, the search of the ordered list is “smart”, in that it only searches those prebuild buffers that are viable to fill the demand.

Once the prebuild buffer is found, there is a check to see if the supply that is associated with the prebuild buffer is within the prebuild limit, at decision block 710. If the answer is ‘yes’, then the decision block 512 is marked ‘yes’ at block 712, and the system proceeds to block 516 in FIG. 5.

If, on the other hand, the supply that is associated with the prebuild buffer is not within the prebuild limit (‘no’ at decision block 710), the system checks to see if there is another prebuild buffer in the ordered prebuild buffer list at decision block 714. If there is no other prebuild buffer, then the decision block 512 is marked as ‘no’ at block 718; the system proceeds to block 514 and marks the demand as late.

However, if there is another prebuild buffer (‘yes’ at decision block 714), then the system proceeds to the next prebuild buffer in the ordered prebuild buffer list at block 716, and repeats the check at decision block 710, until decision block 512 is either marked as ‘yes’ (block 712) or ‘no’ (block 718).

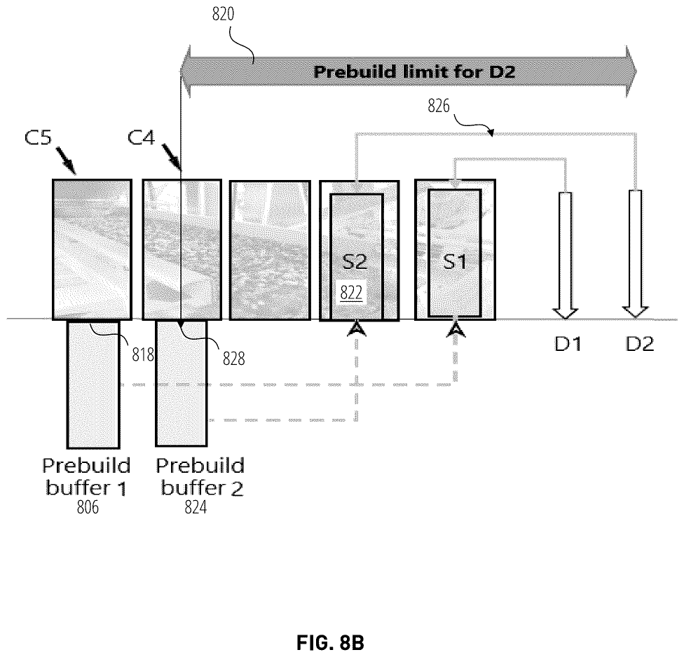

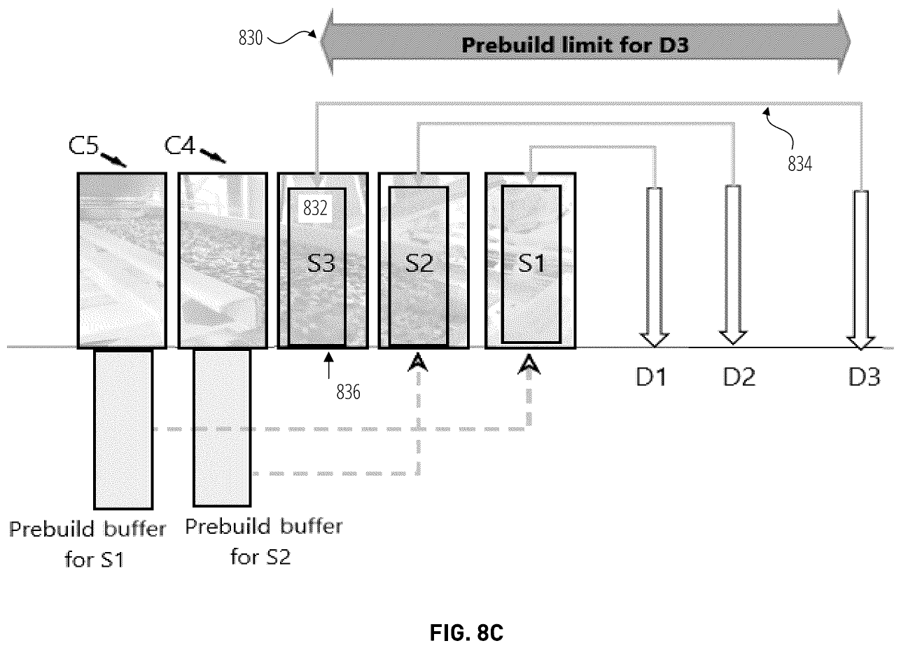

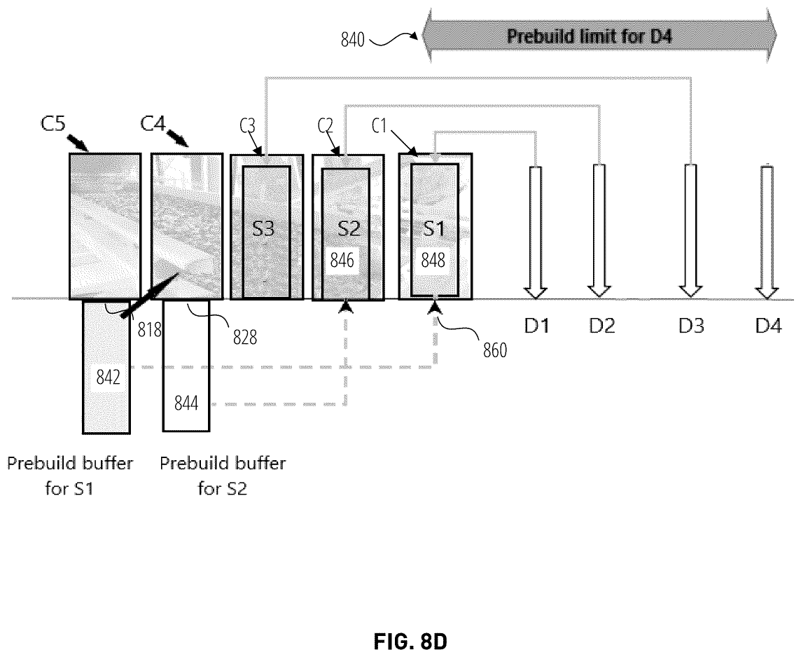

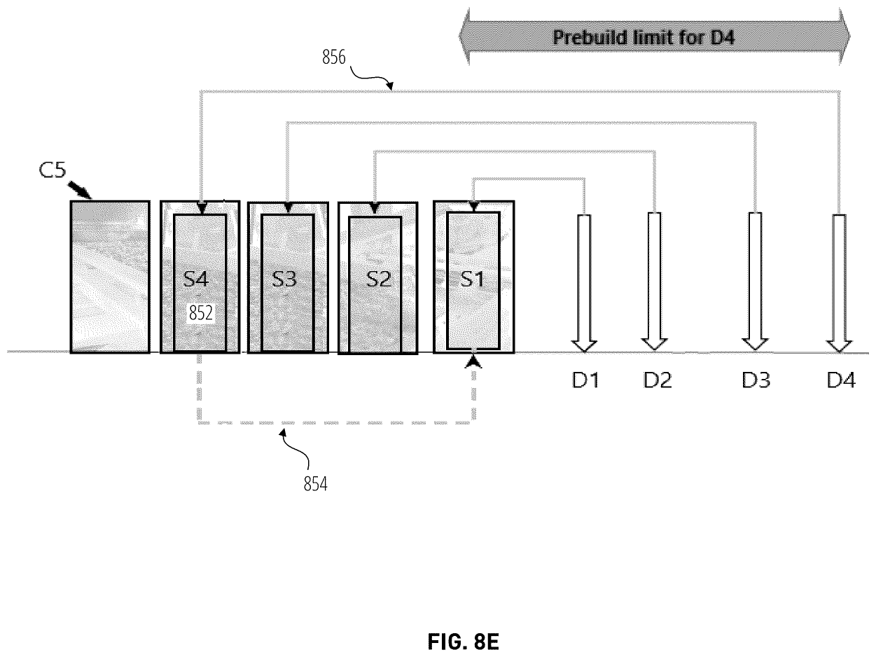

FIG. 8A-FIG. 8D illustrate processing of four demands, D1-D4, in accordance with the block diagram 500, block diagram 600 and block diagram 700. Demands D1-D4 are processed sequentially.

FIG. 8A illustrates processing of Demand D1 in accordance with the block diagram 500 illustrated in FIG. 5. As D1 is the first demand, decision block 502 is ‘yes’, resulting in selection of D1 at block 504. At block 506, prebuild limit 814 for D1 is determined. Next, according to FIG. 8A, there is capacity within the prebuild limit for D1 to make supply for D1 (‘yes’ at decision block 508 in FIG. 5). As such, the supply S1 (804) is made at block 510.

In FIG. 8A, while supply S1 (804) is made for demand D1, it could have been built using capacity C5. This prebuild buffer 806, associated with supply S1 804, is not actually built; it refers simply to a supply that could have been built using an earlier capacity. When a supply S1 (804) is generated, an associated buffer 806 is also generated, which indicates where that supply could have been prebuilt. At block 510, supply S1 804 is made, and information about the prebuild buffer 806 is added to an ordered (or sorted) prebuild buffer list based on block 520 and FIG. 6. This information can be used later to allow for longer prebuild and capacity utilization.

Block diagram 600 illustrates an embodiment for adding information about prebuild buffer 806 to an ordered prebuild buffer list. At the first step, prebuild term 816 is less than prebuild limit 814 (‘yes’ at decision block 602), which means that information about the prebuild buffer 806 is added to an ordered prebuild buffer list at block 606. In some embodiments, this information can include the following: supply of the prebuild buffer is set equal to the supply associated with the prebuild buffer; and a prebuild buffer date is set equal to the prebuild limit date of the demand. With respect to FIG. 8A, supply of the prebuild buffer is set equal to supply S1 (804). The prebuild buffer date is equal to the demand prebuild limit date 818 for demand D1. Since this is the first entry in the ordered prebuild buffer list, the list is automatically ordered at block 608. Therefore, an embodiment of the ordered prebuild buffer list, after processing D1, is as follows:

Ordered Prebuild Buffer List after processing D1

| Prebuild Buffer | Associated Supply | Prebuild Buffer Date |
|---|---|---|
| Prebuild Buffer 1 | Supply S1 | Demand D1 Prebuild Limit Date |

While a simple list is shown above for visualization purposes, the ordered buffer list can be implemented as a binary-tree structure in the computing resources, for ordering and searching purposes.

After block 520, the system proceeds to decision block 502. Since there is Demand D2 (‘yes’ at decision block 502), the next demand is selected at block 504. That demand is D2.

FIG. 8B illustrates processing of Demand D2 in accordance with the block diagram 500 illustrated in FIG. 5. At block 506, prebuild limit 820 for D2 is determined. Next, according to FIG. 8B, there is capacity within the prebuild limit for D2 to make supply for D2 (‘yes’ at decision block 508 in FIG. 5). As such, the supply S2 (822) is made at block 510, using the nearest available capacity to demand D2.

In FIG. 8B, while supply S2 (822) is made for demand D2, it could have been built using capacity C4. This prebuild buffer 824, associated with supply S2 822, is not actually built; it refers simply to a supply that could have been built using an earlier capacity. When a supply S2 (822) is generated, an associated buffer 824 is also generated, which indicates where that supply could have been prebuilt. At block 510, supply S2 822 is made, and information about the prebuild buffer 824 is added to the ordered prebuild buffer list (which already contains information about prebuild buffer 806), based on block 520 and FIG. 6. This information can be used later to allow for longer prebuild and capacity utilization.

Block diagram 600 illustrates an embodiment for adding information about prebuild buffer 824 to the ordered prebuild buffer list. At the first step, prebuild term 826 is less than prebuild limit 820 (‘yes’ at decision block 602), which means that information about the prebuild buffer 824 is added to the ordered prebuild buffer list at block 606. In some embodiments, this information can include the following: supply of the prebuild buffer is set equal to the supply associated with the prebuild buffer, and a prebuild buffer date is set equal to the prebuild limit date of the demand.

With respect to FIG. 8B, supply of the prebuild buffer is set to supply S2 (822). The buffer date is equal to the demand prebuild limit date 828 for demand D2.

At block 608, the information about prebuild buffer 2 (824) is added to the ordered list according to the criteria of the prebuild limit date of the corresponding demand, in chronological order, with the most recent date at the top. With respect to FIG. 8B, The prebuild limit date for demand D2 is shown as 828, whereas the prebuild limit date for demand D1 is shown at 818. Chronologically, 828 occurs later in time than 818, and is thus placed on top of the ordered list.

Therefore, an embodiment of the ordered prebuild buffer list, after processing D2, is as follows:

Ordered Prebuild Buffer List after processing D1 & D2

| Prebuild Buffer | Associated Supply | Prebuild Buffer Date |
|---|---|---|
| Prebuild Buffer 2 | Supply S2 | Demand D2 Prebuild Limit Date |
| Prebuild Buffer 1 | Supply S1 | Demand D1 Prebuild Limit Date |

While a simple list is shown above for visualization purposes, the ordered buffer list can be implemented as a binary-tree structure in the computing resources, for ordering and searching purposes.

After block 520, the system proceeds to decision block 502. Since there is Demand D3 (‘yes’ at decision block 502), the next demand is selected at block 504. That demand is D3.

FIG. 8C illustrates processing of Demand D3 in accordance with the block diagram 500 illustrated in FIG. 5. At block 506, prebuild limit 830 for D3 is determined. Next, according to FIG. 8C, there is capacity within the prebuild limit for D3 to make supply for D3 (‘yes’ at decision block 508 in FIG. 5). As such, the supply S3 (832) is made at block 510, using the nearest available capacity to demand D3.

In FIG. 8C, unlike FIG. 8A and FIG. 8B, while supply S3 (832) is made for demand D3, it could not have been built using any earlier capacity (that is C4 or C5), since these are beyond the prebuild limit 830 for D3. At block 510, supply S3 832 is made. However, no further information is added to the ordered prebuild buffer list, according to block 520 and block diagram 600 (in FIG. 6). With reference to FIG. 6, at the first step at decision block 602, prebuild term 834 is not less than prebuild limit 836 (‘no’ at decision block 602), which means that nothing is added to the ordered prebuild buffer list with reference to supply S3 832 (block 604). Therefore, an embodiment of the ordered prebuild buffer list, after processing D3, is as follows:

Ordered Prebuild Buffer List after processing D1, D2 & D3

| Prebuild Buffer | Associated Supply | Prebuild Buffer Date |
|---|---|---|
| Prebuild Buffer 2 | Supply S2 | Demand D2 Prebuild Limit Date |
| Prebuild Buffer 1 | Supply S1 | Demand D1 Prebuild Limit Date |

While a simple list is shown above for visualization purposes, the ordered buffer list can be implemented as a binary-tree structure in the computing resources, for ordering and searching purposes.

After block 520, the system proceeds to decision block 502. Since there is Demand D4 (‘yes’ at decision block 502), the next demand is selected at block 504. That demand is D4.

FIG. 8D illustrates processing of Demand D4 in accordance with the block diagram 500 illustrated in FIG. 5. At block 506, prebuild limit 840 for D4 is determined. According to FIG. 8D, there is no capacity within the prebuild limit for D4 to make supply for D4 (‘no’ at decision block 508 in FIG. 5), since capacity C1 is used to make supply S1, and is thus unavailable. Note that capacities C2-C5 are beyond the prebuild limit 840 for D4, and cannot be used to make supply for D4; furthermore, capacities C2 and C3 are already assigned supplies S2 and S3, respectively.

The system proceeds to decision block 512 to search the ordered prebuild buffer list. Block diagram 700 in FIG. 7 illustrates an embodiment to determine if there is a prebuild buffer with enough shelf life for the demand.

At this juncture, there are two prebuild buffers (namely, prebuild buffer 842 for supply S1 and prebuild buffer 844 for supply S2) in the ordered prebuild buffer list:

Ordered Prebuild Buffer List after processing D1, D2 & D3

| Prebuild Buffer | Associated Supply | Prebuild Buffer Date |
|---|---|---|
| Prebuild Buffer 2 | Supply S2 | Demand D2 Prebuild Limit Date |
| Prebuild Buffer 1 | Supply S1 | Demand D1 Prebuild Limit Date |

According to block 706, the search is confined to prebuild buffer dates that precede the demand prebuild limit (of Demand D4), which is the date shown at 860. The prebuild buffer date for prebuild buffer 2 is at 828, which is before the prebuild limit date 860 for demand D4. Therefore, the search for a prebuild buffer will begin at prebuild buffer 2 at block 706.

At block 708, the search is executed, beginning at prebuild buffer 2. The most recent prebuild buffer 844 for supply 2, is selected. As shown in FIG. 8D, however, the supply associated with prebuild buffer 844, supply S2 (846) is beyond prebuild limit 840. That is, prebuild buffer 844 cannot be used because its associated supply S2 (846) is not within the prebuild limit 840 and would expire before the end of the demand shelf life of D4. Therefore, the answer is ‘no’ at decision block 710, and the system checks to see if there is another prebuild buffer in the ordered prebuild buffer list at decision block 714. Note that prebuild buffer 844 associated with supply 2 remains in the ordered prebuild buffer list.

There is one more prebuild buffer in the ordered list (‘yes’ at decision block 714), namely prebuild buffer 842, associated with supply S1, which is selected at block 716. As shown in FIG. 8D, supply S1 (848), associated with prebuild buffer 842, is within prebuild limit 840, and would not expire before the end of the demand shelf life of D4. Therefore, the answer is ‘yes’ at decision block 710, and the system proceeds to block 712 and marks decision block 512 as ‘yes’.

At the next block 516 in FIG. 5, prebuild limit 840 for demand D4 is extended as the prebuild buffer 842 (associated with S1) is moved to capacity block C4. This is illustrated in FIG. 8E, where prebuild buffer 842 shown in FIG. 8D has now been generated as supply S4 (852) for demand D4, by using capacity C4. The dashed arrow 854 indicates that supply S4 is associated with supply S1. That is, in accordance with block 516 in FIG. 5, supply S4 is made within the extended prebuild limit 856 for D4. Next, at block 518, the prebuild buffer 842 associated with supply S1 (in FIG. 8D) is removed from the ordered prebuild buffer list, since it has been used up. Therefore, an embodiment of the ordered prebuild buffer list, after processing D4, is as follows:

Ordered Prebuild Buffer List after processing D1, D2, D3 & D4

| Prebuild Buffer | Associated Supply | Prebuild Buffer Date |
|---|---|---|
| Prebuild Buffer 2 | Supply S2 | Demand D2 Prebuild Limit Date |

While a simple list is shown above for visualization purposes, the ordered buffer list can be implemented as a binary-tree structure in the computing resources, for ordering and searching purposes.

The system then proceeds to decision block 502. Since D4 was the final demand, the process ends. The final allotments of supply for all of the demands is shown in FIG. 8E.

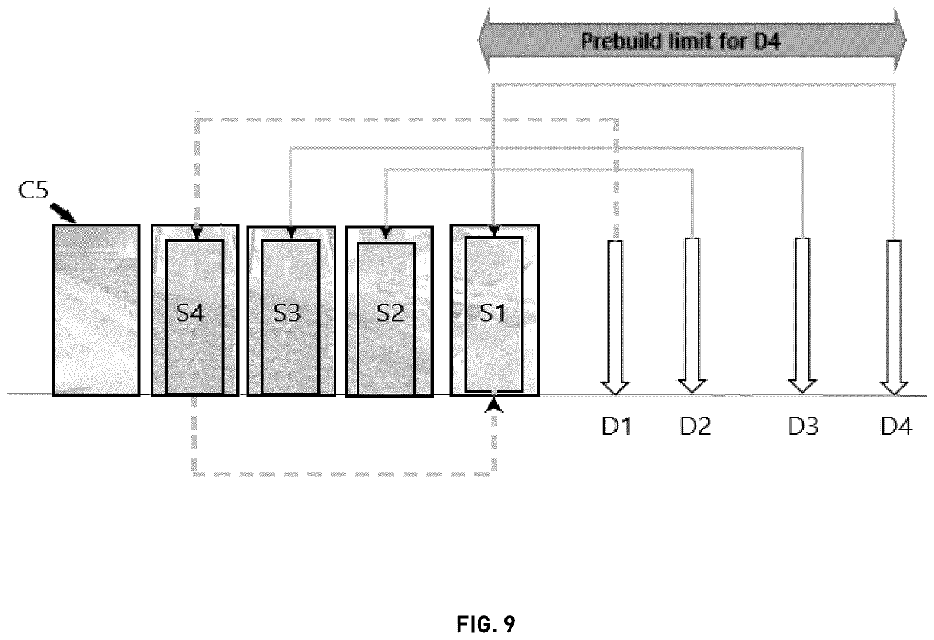

A further step of allocation is shown in FIG. 9, where supply S1 fills demand D4, and supply S4 fills demand D1, since S4, originally prebuild buffer associated with S1, can be switched with S1. Generation and use of one or more prebuild buffers eliminates the need for the computer-intensive process of swap and iteration shown in FIG. 4B. In addition, ordering the list, and executing a “smart” search (whereby only viable prebuild buffers are searched) also reduce computing resources. While ordered lists with up to 2 entries have been shown for example purposes, in reality, ordered lists can have up to hundreds of thousands of entries, with the smart search reducing the search time needed to find a suitable prebuild buffer. Systems and methods disclosed herein arrive at the same result using a more performant algorithm bounded by O(N log N) and improved capacity utilization, as opposed to traditional methods that waste capacity (for example, as shown in FIG. 4A) and/or have a processing time bounded by O(N\hat{ }2), where N is the number of demands.

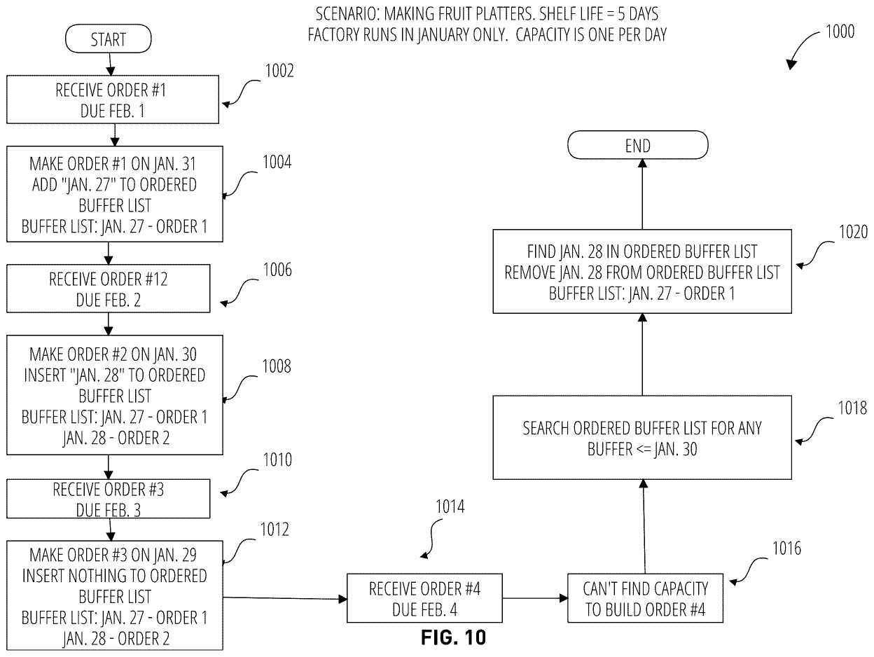

FIG. 10 illustrates an example 1000 of constructing and searching an ordered buffer list in the field of shelf-life/demand, in accordance with one embodiment. In example 1000, the scenario involves making fruit platters, which have a shelf life of 5 days once they are made. The factory that makes the fruit platters only operates during the month of January, and has the capacity to make one fruit platter per day.

At 1002, a first order is received that is due February 1. Since this is the first order, the factory has full capacity to make this order. To keep inventory costs low, at 1004, the fruit platter is made on January 31 (so that it can be shipped out the next day, to meet the order in a timely manner). However, the fruit platter could have been made as far back as January 27, since it has a shelf life of 5 days. The date of January 27 and its association with order #1, are added to the ordered buffer list, as indicated in 1004. The pre-order limit is 5 days, while the pre-order term is 1 day (between January 31, the day of production, and February 1, the day the order is due). Since the pre-order term is less than the pre-order limit, information about a buffer (date of January 27, associated with order #1) is added to an ordered buffer list.

At 1006, a second order is received that is due February 2. To keep inventory costs low, at 1108, the fruit platter is made in January as close to the due date of February 2, since the factory only operates in January. Since the factory is already busy January 31 (due to the first order), the fruit platter is made on January 30. However, the fruit platter could have been made as far back as January 28, since it has a shelf life of 5 days. The date of January 28 and its associated order #2 are added to the ordered buffer list, as indicated in 1108. The ordered buffer list has these dates in the follow order: January 27 and January 28. Here, the pre-order limit is 5 days, while the pre-order term is 3 days (between January 30, the day of production, and February 2, the day the order is due). Since the pre-order term is less than the pre-order limit, information about a buffer (date of January 28, associated with order #2) is added to the ordered buffer list.

At 1010, a third order is received that is due February 3. To keep inventory costs low, at 1012, the fruit platter is made in January as close to the due date of February 3, since the factory only operates in January. Since the factory is already busy January 30-31 (due to the first two orders), the fruit platter is made on January 29, the last possible date to make the fruit platter. There is no buffer date before January 29 to make the order due February 3, since any fruit platter made before January 29 will spoil by the due date of February 3. There is no buffer date added to the ordered buffer list at 1012. The ordered buffer list remains as it was at 1008. Here, the pre-order limit is 5 days, while the pre-order term is 5 days (between January 29, the day of production, and February 13, the day the order is due). Since the pre-order term is not less than the pre-order limit, no further information is added to the ordered buffer list.

At 1014, a fourth order is received that is due February 4. To keep inventory costs low, the fruit platter is made in January as close to the due date of February 4, since the factory only operates in January. To maintain within the 5-day shelf life, the only possible dates to make this order are January 30 or January 31. The buffer limit date is January 30—that is, the fruit platter cannot be made before this date since it will spoil by the due date of February 4. However, the factory has already allocated January 29-31 to make the first three orders. There is no capacity to make this fruit platter (box 1016).

The ordered buffer list is then searched at 1018 to see if there are any buffers available before the buffer limit date of January 30. At 1020, the date of January 28 is found in the ordered buffer list; it is associated with Order #2 with a manufacture date of January 30. This is a viable buffer for Order #4. As such, the buffer with a January 28 date is removed from the ordered buffer list. The ordered buffer list now only has one entry: January 27, associated with Order #1, as shown at 1020.

Systems and methods for improved computer efficiency disclosed above can be applied to a myriad of situations that are not related to shelf-life and demand. Systems and methods disclosed herein can be generalized to maximizing capacity utilization with generalized constraints. A few examples are discussed below.

Cost of material. If a demand can be made from several grades of material ranging from cheap to expensive, the cheapest material (that is, the most preferred option) is used. A buffer is inserted in an efficient data structure (for example, an ordered list) for expensive material. Later, if another demand requires cheaper material, the ordered list is searched in a smart manner until a suitable buffer is found and used.

Distance. If a demand can accept supplies from a range of warehouses ranging from shorter to longer distances, the warehouse with the shortest distance is selected. A buffer is inserted in an efficient data structure (that is, an ordered list). Later if another demand requires a shorter distance, the ordered list is searched in a smart manner until a suitable buffer is found and used.

Delivery date. If a customer can accept goods from today to up to 5 days later, the delivery is scheduled for today, while a buffer is inserted into an ordered list. Later, if another customer must have the same goods today, the ordered list is searched in a smart manner until a suitable buffer is found and used. Alternatively, if the other customer wants the same goods but only on Days 2 and 3, the ordered list is searched in a smart manner until a suitable buffer is found and used, in a similar manner.

Airline ticket system. An airline has acceptable price ranges and aims to maximize its income. As with the shelf-life/demand scenario, there is a range (of dollar values) and once a customer purchases a ticket, an algorithm charges the customer a maximum possible amount, while keeping track of a “buffer” between what the customer has paid and the lowest price that the airline is willing to charge. If needed later, the buffer information can be used to drop the price with alternative dates to increase utilization of airline planes for newer customer. This method can be generalized to other pricing systems—not only for airlines.

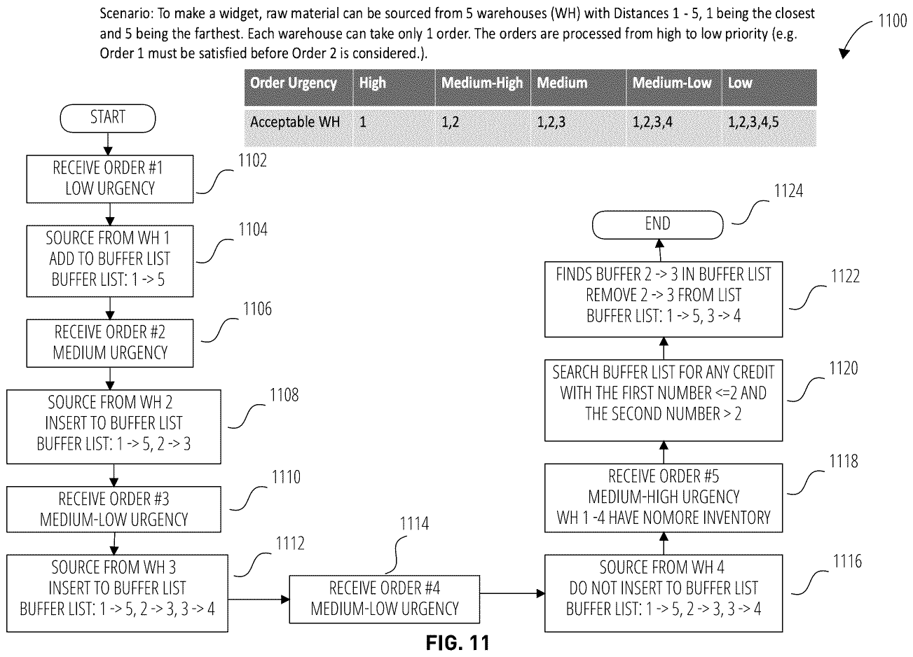

FIG. 11 illustrates an example 1100 of constructing and searching an ordered buffer list, in accordance with one embodiment.

In example 1100, the scenario involves making a widget from raw material that can be sourced from any one of 5 warehouses (WH) at a distance 1-5, with ‘1’ being the closest and ‘5’ being the farthest. Each warehouse can only take 1 order at a time. In example 1100, a high-priority order can only be handled by WH 1; a medium-high priority order can only be handled by any one of WH 1-2; a medium-priority order can only be handled by any one of WH 1-3; a medium-low priority order can only be handled by any one of WH 1-4; and a low-priority order can only be handled by any one of WH 1-5.

At 1102, a first order is received that has low urgency. As such, the raw material to make this widget can be sourced from any one of warehouses 1 to 5. To keep transportation costs and greenhouse gases (GHG) minimal for this order, at 1104, the widget is sourced from WH 1. However, the widget could have been sourced from any one of WH 2-5, with WH 5 being the farthest, due to the low urgency of the order. The ordered buffer list at this stage includes the information “1→5”, associated with Order #1, meaning that the order is sourced from WH 1, but can moved up to WH 5.

Here, the pre-order term can be defined as the distance (or Warehouse number) that is sourced, while the pre-order limit can be defined as the farthest distance (or Warehouse number) that can be sourced to fill the order. Here, for Order #1, the pre-order term is 1, while the pre-order limit is 5. Since the pre-order term is less than the pre-order limit, information “1→5”, associated with Order #1 (meaning that the order is sourced from WH 1, but can moved up to WH 5) is added to an ordered buffer list.

At 1106, a second order is received that has medium urgency. As such, the raw material to make this widget can be sourced from any one of warehouses 1 to 3. However, WH 1 has already been allocated to the first order (see 1104), meaning that only WH 2 and WH 3 can be sourced. To keep transportation costs and greenhouse gases (GHG) minimal for this order, at 1108, the widget is sourced from WH 2. However, the widget could have been sourced from WH 3. The ordered buffer list at this stage includes the prior information “1→5”, and the new information “2→3” (meaning that the order is sourced from WH 2, but can moved up to WH 3).

Here, for Order #2, the pre-order term is 2, while the pre-order limit is 3. Since the pre-order term is less than the pre-order limit, information “2→3”, associated with Order #2 (meaning that the order is sourced from WH 2, but can moved up to WH 3) is added to the ordered buffer list.

At 1110, a third order is received that has medium-low urgency. As such, the raw material to make this widget can be sourced from any one of warehouses 1 to 4. However, WH 1 and WH 2 have already been allocated to the first order (see 1104) and second order (see 1108) respectively, meaning that only WH 3 and WH 4 can be sourced. To keep transportation costs and greenhouse gases (GHG) minimal for this order, at 1112, the widget is sourced from WH 3. However, the widget could have been sourced from WH 4. The ordered buffer list at this stage includes the prior information “1→5”, “2→3”, and the new information “3→4” (meaning that the order is sourced from WH 3, but can moved up to WH 4).

Here, for Order #3, the pre-order term is 3, while the pre-order limit is 4. Since the pre-order term is less than the pre-order limit, information “3→4”, associated with Order #3 (meaning that the order is sourced from WH 3, but can moved up to WH 4) is added to the ordered buffer list.

At 1114, a fourth order is received that has medium-low urgency. As such, the raw material to make this widget can be sourced from any one of warehouses 1 to 4. However, WH 1, WH 2 and WH 3 have already been allocated to the first order (see 1104), second order (see 1108), and third order (see 1112) respectively, meaning that only WH 4 can be sourced. Therefore, for this order, at 1116, the widget is sourced from WH 4. Since there is only one possible warehouse for sourcing this order, nothing is added to the buffer list. The ordered buffer list at this stage remains as it was at 1112; it includes the prior information “1→5”, “2→3”, and “3→4”.

Here, for Order #4, the pre-order term is 4, while the pre-order limit is 4. Since the pre-order term is not less than the pre-order limit, no further information is added to the ordered buffer list.

At 1118, a fifth order is received that has medium-high urgency. As such, the raw material to make this widget can be sourced from any one of warehouses 1 to 2. However, WH 1 and WH 2 have already been allocated to the first order (see 1104) and second order (see 1108). There is no warehouse apparently available to source this order. The furthest WH for this order is WH 2. At 1120, the ordered buffer list is searched for any buffer having a first WH number less than or equal to 2, and a second WH number greater than 2. The ordered buffer list at this stage includes the following information, in the following order: “1→5”, “2→3”, and “3→4”. Rather than execute the search from the very first entry (1→5), a smart search based on the criterion at 1120, begins at 2→3 at 1122. The buffer “2→3” is found in the ordered buffer list, and used; it is removed from the ordered buffer list, which at this stage, now includes the following ordered information: “1→5” and “3→4”. The process ends at 1124.

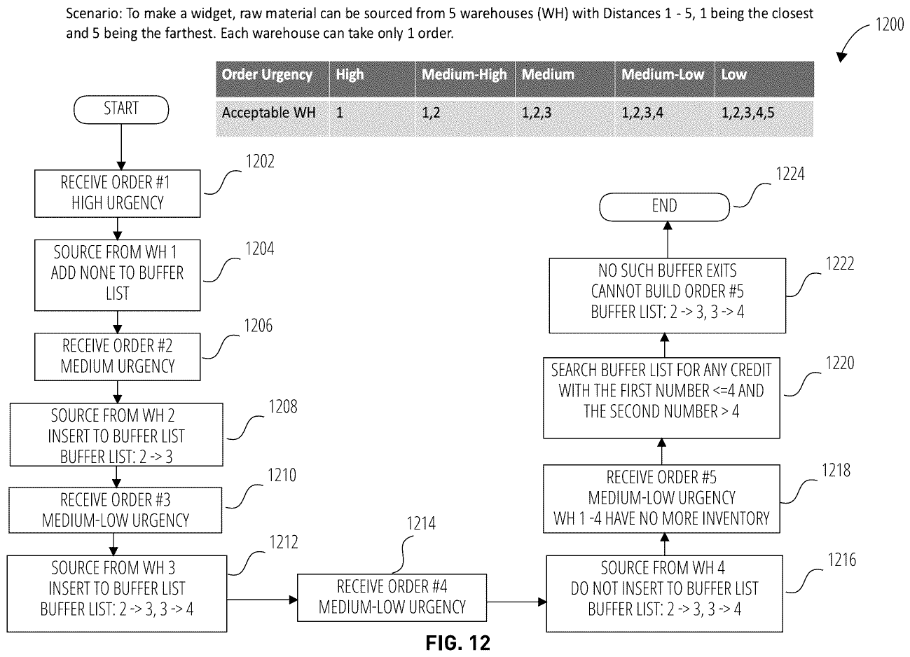

FIG. 12 illustrates an example 1200 of constructing and searching an ordered buffer list, in accordance with one embodiment.

In example 1200, the scenario involves making a widget from raw material that can be sourced from any one of 5 warehouses (WH) at a distance 1-5, with ‘1’ being the closest and ‘5’ being the farthest. Each warehouse can only take 1 order at a time. In example 1100, a high-priority order can only be handled by WH 1; a medium-high priority order can only be handled by any one of WH 1-2; a medium-priority order can only be handled by any one of WH 1-3; a medium-low priority order can only be handled by any one of WH 1-4; and a low-priority order can only be handled by any one of WH 1-5.

At 1202, a first order is received that has high urgency. As such, the raw material to make this widget can be sourced only from WH 1. There is no possible buffer to add. At 1204, the raw material is sourced from WH 1, while nothing is added to the buffer list.

As in FIG. 11, the pre-order term can be defined as the Warehouse number that is sourced, while the pre-order limit can be defined as the farthest Warehouse number that can be sourced to fill the order. Here, for Order #1, the pre-order term is 1, while the pre-order limit is 1. Since the pre-order term is not less than the pre-order limit, no information is added to an ordered buffer list.

At 1206, a second order is received that has medium urgency. As such, the raw material to make this widget can be sourced from any one of warehouses 1 to 3. However, WH 1 has already been allocated to the first order (see 1204), meaning that only WH 2 and WH 3 can be sourced. To keep transportation costs and greenhouse gases (GHG) minimal for this order, at 1208, the widget is sourced from WH 2. However, the widget could have been sourced from WH 3. The ordered buffer list at this stage includes the information “2→3” (meaning that the order is sourced from WH 2, but can moved up to WH 3).

Here, for Order #2, the pre-order term is 2, while the pre-order limit is 3. Since the pre-order term is less than the pre-order limit, information “2→3”, associated with Order #2 (meaning that the order is sourced from WH 2, but can moved up to WH 3) is added to an ordered buffer list.

At 1210, a third order is received that has medium-low urgency. As such, the raw material to make this widget can be sourced from any one of warehouses 1 to 4. However, WH 1 and WH 2 have already been allocated to the first order (see 1204) and second order (see 1208) respectively, meaning that only WH 3 and WH 4 can be sourced. To keep transportation costs and greenhouse gases (GHG) minimal for this order, at 1212, the widget is sourced from WH 3. However, the widget could have been sourced from WH 4. The ordered buffer list at this stage includes the prior information “2→3”, and the new information “3→4” (meaning that the order is sourced from WH 3, but can moved up to WH 4).

Here, for Order #3, the pre-order term is 3, while the pre-order limit is 4. Since the pre-order term is less than the pre-order limit, information “3→4”, associated with Order #3 (meaning that the order is sourced from WH 3, but can moved up to WH 4) is added to the ordered buffer list.

At 1214, a fourth order is received that has medium-low urgency. As such, the raw material to make this widget can be sourced from any one of warehouses 1 to 4. However, WH 1, WH 2 and WH 3 have already been allocated to the first order (see 1204), second order (see 1208), and third order (see 1212) respectively, meaning that only WH 4 can be sourced. Therefore, for this order, at 1216, the widget is sourced from WH 4. Since there is only one possible warehouse for sourcing this order, nothing is added to the buffer list. The ordered buffer list at this stage remains as it was at 1212; it includes the prior information “2→3” and “3→4”.

Here, for Order #4, the pre-order term is 4, while the pre-order limit is 4. Since the pre-order term is not less than the pre-order limit, no information is added to an ordered buffer list.

At 1218, a fifth order is received that has medium-low urgency. As such, the raw material to make this widget can be sourced from any one of warehouses 1 to 4. However, WH 1, WH 2, WH 3 and WH 4 have already been allocated to the first order (see 1204), second order (see 1208), the third order (see 1212), and the fourth order (see 1216) respectively. There is no warehouse apparently available to source this order. The furthest WH for this order is WH 4. At 1220, the ordered buffer list is searched for any buffer having a first WH number less than or equal to 4, and a second WH number greater than 4. The ordered buffer list at this stage includes the following information, in the following order: “2→3”, and “3→4”. Rather than execute the search from the very first entry (2→3), a smart search based on the criterion at 1220, begins the search at an entry beginning with ‘4’. Since none exists, no further search is performed. There is no buffer and the order cannot be filled. The buffer list remains as it was at 1216, namely with the the prior information “2→3” and “3→4”. The process ends at 1224.

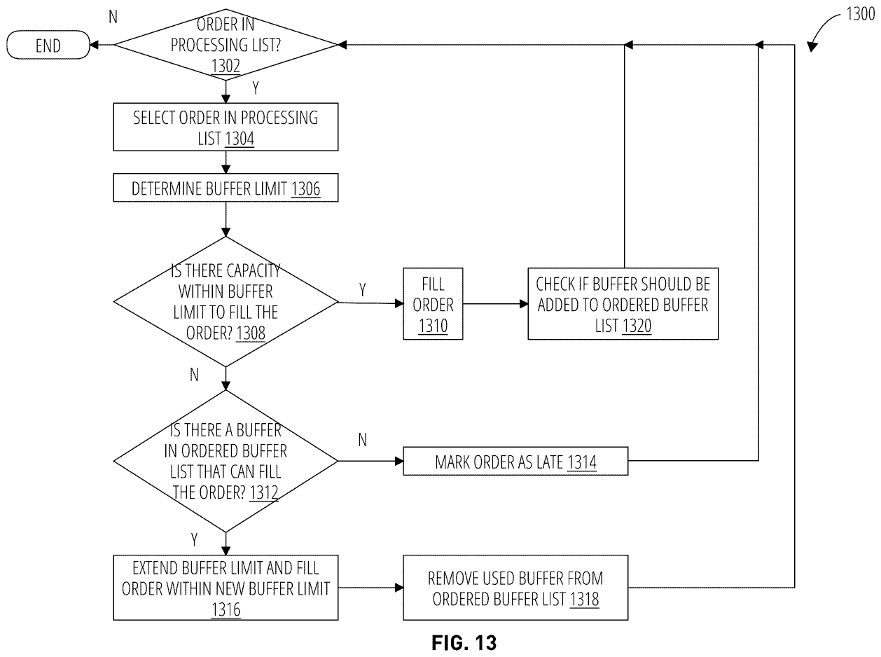

FIG. 13 illustrates a block diagram in accordance with one embodiment, which generalizes block diagram 500 of FIG. 5. Block diagram 1300 can be used for the processing of orders shown in FIG. 10-FIG. 12.

The first steps involve selecting an order. At the outset, since there is an order in a processing list (‘yes’ at decision block 1302), the top order in the processing list is selected for processing, at block 1304. The processing list can be arranged in any order. As an example, the processing list can be chronological, by priority, or any combination thereof.

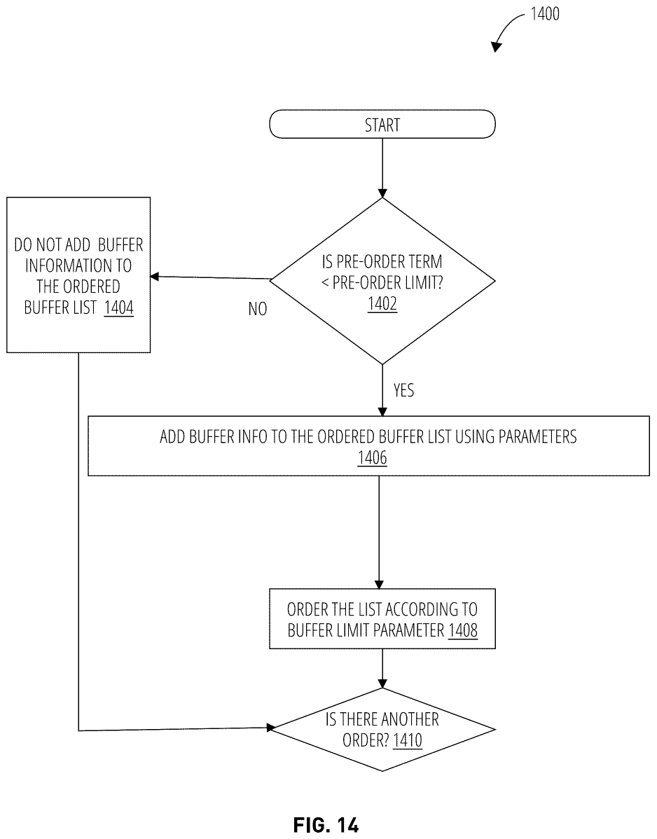

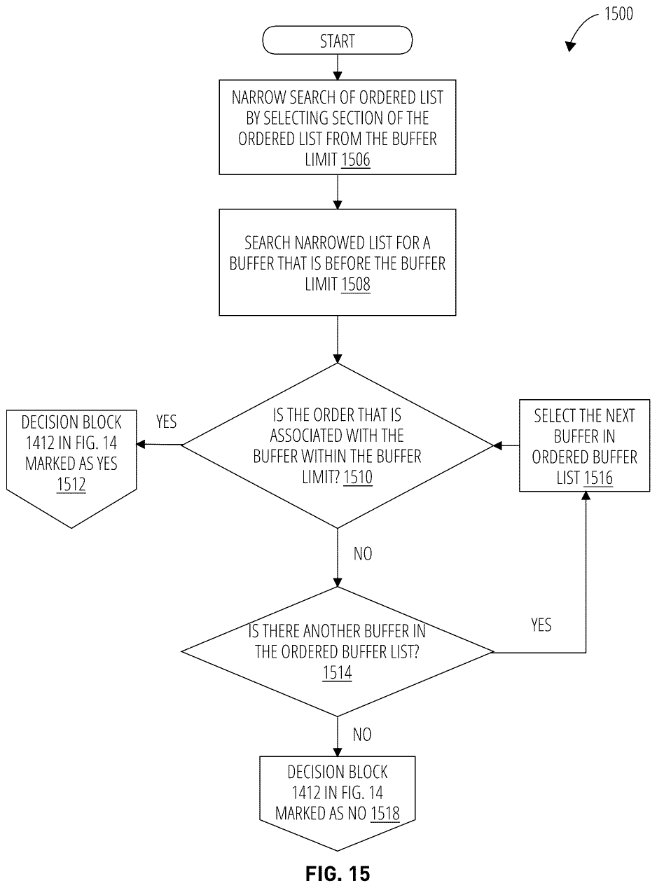

Next, at block 1306, a buffer limit for the order is determined, based on the constraints of the process. Next, the system checks to see if the order can be filled using capacity within the buffer limit at decision block 1308. If the answer is ‘yes’, then the order is filled at block 1310 and the system checks to see if a buffer is to be added to an ordered buffer list at block 1320. An ordered buffer list helps to improve algorithm efficiency. To improve algorithm efficiency, the buffers can be stored in a data structure that allows finding eligible buffers for a particular demand to be more efficient than linear search. For example, the data structure can be a list ordered by earliest usable dates of buffers. An embodiment for constructing an ordered buffer list is illustrated in FIG. 14. The next order in the list is processed at block 1304; otherwise the process ends if there are no further orders in the processing list.

On the other hand, at decision block 1308, if the order cannot be filled due to a lack of capacity (‘no’ at decision block 1308), the ordered buffer list is checked for a buffer that can fill the order, at decision block 1312. If no such buffer is found (‘no’ at decision block 1312), the order is marked as late at block 1314. The system then proceeds to the next order in the processing list, or ends if no more orders remain to be processed.

If, however, at decision block 1312, a buffer can be found in the ordered buffer list (‘yes’ at decision block 1312), then the buffer limit of the order is extended, and the order is filled within the new buffer limit at block 1316. Next, at block 1318, the used buffer is removed from the ordered buffer list. The system then proceeds to the next order in the processing list, or ends if no more orders remain to be processed.

FIG. 14 illustrates a block diagram 1400 for deciding whether or not to add information to an ordered buffer list a in accordance with one embodiment, with reference to block 1320 in FIG. 13. Block diagram 1400 can be used for the processing of orders shown in FIG. 10-FIG. 12.

A pre-order term is first checked against a pre-order limit at decision block 1402. The pre-order term and the pre-order limit can be defined according to the scenario under consideration. For example, a pre-order term can be a time interval between a date of production and a date the production is due and the pre-order limit can be defined as a time interval for expiry of the product (see for example, the fruit platter example in FIG. 10). In another example, a pre-order term can be a distance for sourcing material from a warehouse, and the pre-order limit can be defined as the farthest allowable distance for sourcing the material from a warehouse (see for example, the widget examples in FIG. 11 and FIG. 12).

If the pre-order term is not less than the pre-order limit (‘no’ at decision block 1402), then no information is added to the ordered buffer list (block 1404). However, if the pre-order term is less than the pre-order limit (‘yes’ at decision block 1402), then information about the buffer is added to the ordered buffer list. In some embodiments, this information can include the following: a supply associated with the prebuild buffer; and a prebuild buffer date is set equal to the prebuild limit date of the demand. Next, at block 1408, the list is ordered according to the pre-order limit date, in chronological order. The ordered list is a data structure, which can be implemented as binary-tree structure.

Whether the decision is ‘yes’ or ‘no’ at decision block 1402, the process eventually winds up at 1410 to process the next demand (if there is one), which is equivalent to decision block 1302 in FIG. 13; that is, if there is no further demand to process, then the process ends. If there is another demand to process, the process proceeds to block 1304 of FIG. 13.

FIG. 15 illustrates a block diagram 1500 for finding a buffer in the buffer list that can fill the order, in accordance with one embodiment, with reference to decision block 1312 in FIG. 13. Block diagram 1600 can be used for the processing of orders shown in FIG. 10-FIG. 12.

Rather than search the entire ordered list (which requires computing resources) for a buffer to fill an order, only a viable section of the ordered buffer list is searched, thus leading to less use of computing resources. The ordered list is a data structure, that can be implemented as a binary-tree structure.

At block 1506, search of the ordered buffer list is narrowed by selecting a section of the ordered buffer list. At block 1508, the search is executed by searching the ordered buffer list for a buffer that is before a buffer limit. Thus, the search of the ordered buffer list is “smart”, in that it only searches those buffers that are viable to fill the order.

Once the buffer is found, there is a check to see if the order that is associated with the buffer is within the buffer limit, at decision block 1510. If the answer is ‘yes’, then the decision block 1512 is marked ‘yes’, and the system proceeds to decision block 1312 in FIG. 13.

If, on the other hand, the order that is associated with the buffer is not within the buffer limit (‘no’ at decision block 1510), the system checks to see if there is another buffer in the ordered buffer list at decision block 1514. If there is no other buffer (‘no’ at decision block 1514), then the decision block 1312 is marked as ‘no’ at block 1518; the system proceeds to block 1314 in FIG. 13.

However, if there is another buffer (‘yes’ at decision block 1514), then the system proceeds to the next buffer in the ordered buffer list at block 1516, and repeats the check at decision block 1510, until decision block 1312 is either marked as ‘yes’ (block 1512) or ‘no’ (block 1518).

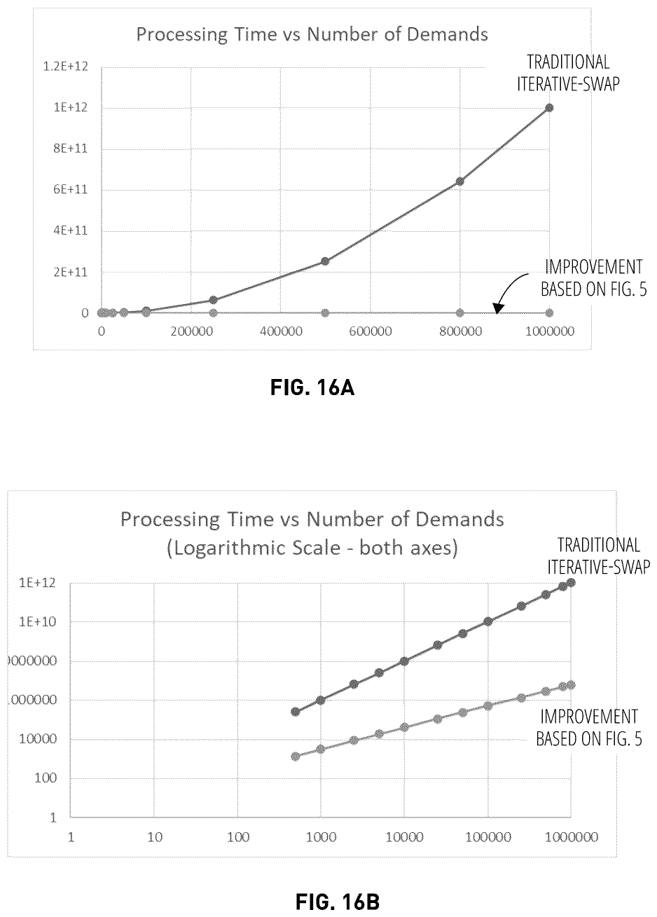

FIG. 16A illustrates improvement in computer processing time in accordance with one embodiment. The graph shows the processing time versus the number of demands, using two different methods. The top-most is the traditional iterative-swap method that maximizes capacity utilization, while the bottom illustrates the improvement in processing time using block diagram 500, in which capacity utilization is also maximized. The number of demands can range from a minimum of 10\hat{ }2. This graph shows the enhanced improvement by generating and using a prebuild buffer list.

FIG. 16B illustrates improvement in computer processing time in accordance with one embodiment. The graph shows log of the processing time versus log of the number of demands, using two different methods. The top-most is the traditional iterative-swap method that maximizes capacity utilization, while the bottom illustrates the improvement in processing time using block diagram 500 or block diagram 1300, in which capacity utilization is also maximized. The number of demands ranges from 10²-10⁶. This graph shows the enhanced improvement at even the lower number of demands, by generating and using a prebuild buffer list.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A system comprising:
a processor; and
a memory storing instructions that, when executed by the processor, configure the system to:
select an order from a sequence of orders,
determine a buffer limit for the order from conditions placed on the order;
where there is capacity within the buffer limit to fill the order:
instruct an entity to fill the order; and
determine whether buffer information should be added to an ordered buffer list based on a pre-order limit and a pre-order term associated with the order; and
where there is no capacity within the buffer limit to fill the order:
search a portion of the ordered buffer list beginning at a point nearest to the buffer limit;
select a buffer within the the portion of the ordered buffer list that is within the buffer limit;
extend the buffer limit;
instruct the entity to fill the order within the extended buffer limit; and
remove the selected buffer from the ordered buffer list.

2. The system of claim 1, wherein the ordered buffer list is a binary tree structure.

3. The system of claim 1, wherein when there is no buffer in the ordered prebuild buffer list that is within the buffer limit, the system is configured to:
mark the order as late.

4. A non-transitory computer-readable storage medium, the computer-readable storage medium including instructions that when executed by a computer, cause the computer to:
select an order from a sequence of orders,
determine a buffer limit for the order from conditions placed on the order;
where there is capacity within the buffer limit to fill the order:
instruct an entity to fill the order; and
determine whether buffer information should be added to an ordered buffer list based on a pre-order limit and a pre-order term associated with the order; and
where there is no capacity within the buffer limit to fill the order:
search a portion of the ordered buffer list beginning at a point nearest to the buffer limit;
select a buffer within the the portion of the ordered buffer list that is within the buffer limit;
extend the buffer limit;
instruct the entity to fill the order within the extended buffer limit; and
remove the selected buffer from the ordered buffer list.

5. The non-transitory computer-readable storage medium of claim 4, wherein the ordered buffer list is a binary tree structure.

6. The non-transitory computer-readable storage medium of claim 4, wherein when there is no buffer in the ordered prebuild buffer list that is within the buffer limit, the computer is configured to:
mark the order as late.

7. A computer-implemented method for maximizing capacity utilization with prebuild constraints, the method comprising:
selecting, by a processor, an order from a sequence of orders,
determining, by the processor, a buffer limit for the order from conditions placed on the order;
where there is capacity within the buffer limit to fill the order:
instructing, by the processor, an entity to fill the order; and
determining, by the processor, whether buffer information should be added to an ordered buffer list based on a pre-order limit and a pre-order term associated with the order; and
where there is no capacity within the buffer limit to fill the order:
searching, by the processor, a portion of the ordered buffer list beginning at a point nearest to the buffer limit;
selecting, by the processor, a buffer within the portion of the the ordered buffer list that is within the buffer limit;
extending, by the processor, the buffer limit;
instructing, by the processor, the entity to fill the order within the extended buffer limit; and
removing, by the processor, the selected buffer from the ordered buffer list.

8. The computer-implemented method of claim 7, wherein the ordered buffer list is a binary tree structure.

9. The computer-implemented method of claim 7, wherein when there is no buffer in the ordered prebuild buffer list that is within the buffer limit, the method further comprises:
marking, by the processor, the order as late.

10. A system comprising:
a processor; and
a memory storing instructions that, when executed by the processor, configure the system to:
select a demand from a sequence of demands,
obtain a prebuild limit from a demand shelf life of the demand, and a supply shelf life of a supply;
where there is capacity within the prebuild limit to fill the demand:
instruct an entity to make the supply; and
determine whether information related to a prebuild buffer associated with the supply should be added to an ordered buffer list, based on the prebuild limit and a prebuild term associated with the order;
and
where there is no capacity within the prebuild limit to fill the demand:
search a portion of the ordered prebuild buffer list beginning at a nearest date to the prebuild limit;
select a prebuild buffer within the ordered prebuild buffer list that is within the prebuild limit;
extend the prebuild limit;
instruct the entity to make the supply; and
remove the selected prebuild buffer from the ordered prebuild buffer list.

11. The system of claim 10, wherein when there is no prebuild buffer in the ordered prebuild buffer list that is within the prebuild limit, the system is configured to:
mark the demand as late.

12. The system of claim 11, wherein the information related to the prebuild buffer comprises:
a supply generated for the prebuild buffer is set equal to the supply associated with the prebuild buffer; and
a prebuild buffer date is set equal to a prebuild limit date of the demand.

13. The system of claim 11, wherein the ordered prebuild buffer list is a binary tree structure.

14. The system of claim 11, wherein when the prebuild term is less than the prebuild limit, the system is configured to:
add information related to the prebuild buffer associated with the supply to the ordered prebuild buffer list that is listed in chronological order of a prebuild demand limit associated with the supply.
